(19) United States
(12) Patent Application Publication
(10) Pub. No.: US 2011/0033218 A1
(43) Pub. Date: Feb. 10, 2011

(54) STAPLING APPARATUS, FINISHING APPARATUS, AND STAPLING METHOD

(75) Inventor: Katsuya SASAHARA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/844,714

(22) Filed: Jul. 27, 2010

Related U.S. Application Data
(60) Provisional application No. 61/231,193, filed on Aug. 4, 2009.

(51) Int. Cl. G03G 15/00; B41F 13/66

(52) U.S. Cl. 399/410; 270/58.08

(57) ABSTRACT

A stapling apparatus includes: a stapler having an opening, into which plural sheets are inserted while being laid one on top of another, and configured to staple one end of the sheets; first and second switches configured to be turned on when the sheets are inserted into the opening of the stapler and respective edges of adjacent two sides of the sheets are pressed; and a stapler driving unit configured to instruct the stapler to perform stapling when both the first and second switches are turned on.

### CROSS-REFERENCE TO RELATED APPLICATION

This application is based upon and claims the benefit of priority from U.S. provisional patent application No. 61/231,193 filed on Aug. 4, 2009. The entirety of the provisional patent application is incorporated herein by reference.

### FIELD

Embodiments described herein relate generally to a stapling apparatus, a finishing apparatus configured to apply finishing to sheets discharged from an image forming apparatus such as a copying machine, a printer, or a multifunction peripheral, and a stapling method.

### BACKGROUND

In recent years, in some image forming apparatus, a finishing apparatus is provided adjacent to a paper discharge unit of a main body of the image forming apparatus in order to perform finishing of sheets, for example, separate sheets after image formation or staple the sheets. In such a finishing apparatus, stapling can be performed according to setting by a user in order to bind sheets subjected to image formation.

Usually, stapling is automatically performed by designating the stapling by, for example, pressing a button before performing image formation or the like. There is known a finishing apparatus that can staple any kind of sheets at the same angle.

However, in some cases, the user forgets to give an instruction for stapling that the user should give beforehand or the user desires to staple sheets subjected to image formation and discharged after checking the sheets. In such a case, it is desirable that the user can immediately staple a desired number of copies of discharged sheets on the spot.

There is also known an image forming apparatus including a stapler that can be removed for use.

Embodiments provide a stapling apparatus, a finishing apparatus for an image forming apparatus that can staple discharged sheets without being removed, and a stapling method.

### BRIEF DESCRIPTION OF THE DRAWINGS

FIG. 1 is a perspective view of a main part of a finishing apparatus according to an embodiment;

FIG. 2 is a schematic diagram of the finishing apparatus according to the embodiment;

FIG. 3 is a perspective view of a stapling and a moving mechanism for the stapling apparatus of the finishing apparatus according to the embodiment;

FIG. 4 is a schematic front view of a paddle according to the embodiment;

FIG. 5 is a perspective view of longitudinal alignment rollers according to the embodiment;

FIG. 6 is a schematic perspective view of lateral alignment plates according to the embodiment;

FIG. 7 is a schematic front view of a state in which a sheet on a waiting tray or a paper discharge tray according to the embodiment is pushed out;

FIG. 8 is a diagram of a relation between a stapler and a slit in the embodiment;

FIG. 9 is a perspective view of the structure of a frame to which the stapler according to the embodiment is attached;

FIG. 10 is a perspective view of a stapler moving mechanism in a state in which the stapler according to the embodiment is attached to the frame shown in FIG. 9;

FIG. 11 is an explanatory diagram of a state in which a sheet bundle is inserted into the stapler in the embodiment;

FIG. 12 is a diagram of a configuration example of an electric circuit of an insertion stapling unit at the time when the sheet bundle is stapled;

FIG. 13 is a plan view of an operation surface of the finishing apparatus according to the embodiment; and

FIG. 14 is a flowchart for explaining operation according to the embodiment.

### DETAILED DESCRIPTION

In general, according to one embodiment, a stapling apparatus includes: a stapler having an opening, into which plural sheets are inserted while being laid one on top of another, and configured to staple one end of the sheets; first and second switches configured to be turned on when the sheets are inserted into the opening of the stapler and respective edges of adjacent two sides of the sheets are pressed; and a stapler driving unit configured to instruct the stapler to perform stapling when both the first and second switches are turned on.

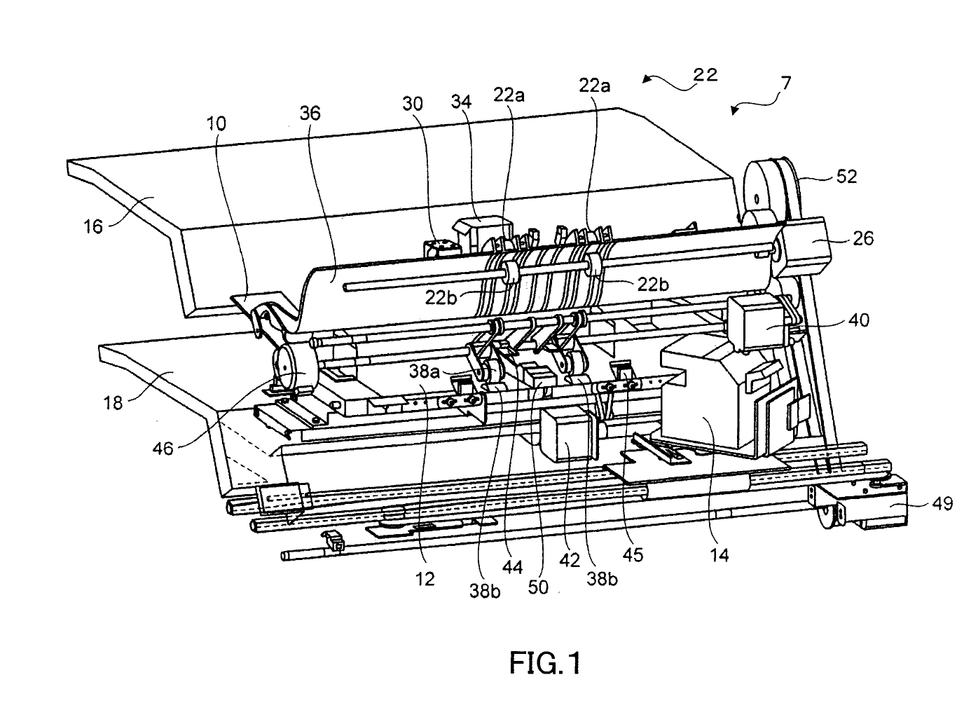

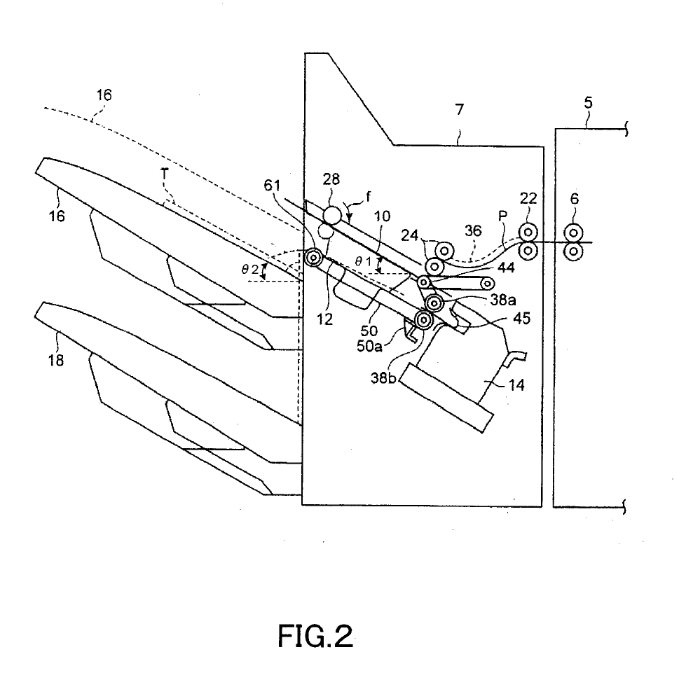

Embodiments are explained below with reference to the accompanying drawings. The same components are denoted by the same reference numerals and signs in the drawings and redundant explanation of the components is omitted. FIG. 1 is a perspective view of a main part of a finishing apparatus 7 incorporating a stapler according to an embodiment. FIG. 2 is a schematic diagram of the finishing apparatus 7 arranged adjacent to an image forming apparatus 5 such as a copying machine.

The finishing apparatus 7 basically includes a waiting tray 10, a processing tray 12, a stapler 14, a first paper discharge tray 16, and a second paper discharge tray 18. The waiting tray 10 has a pair of sheet supporting surfaces openable and closable to the left and right. When the pair of sheet supporting surfaces are opened, a stacked group of sheets falls from the waiting tray 10 onto the processing tray 12.

As shown in FIG. 2, a sheet P subjected to image formation in the image forming apparatus 5 such as a copying machine and discharged from a pair of paper discharge rollers 6 is received by a pair of inlet rollers 22, supplied to a pair of paper feeding rollers 24, and fed from the paper feeding rollers 24 to the waiting tray 10. The inlet rollers 22 are driven by an inlet roller motor 26. A paper guide 36 configured to guide the sheet P to the paper feeding rollers 24 is provided between the inlet rollers 22 and the waiting tray 10. The inlet rollers 22 include an upper inlet roller 22a and a lower inlet roller 22b. Similarly, the paper feeding rollers 24 include an upper paper feeding roller and a lower paper feeding roller.

The processing tray 12 on which the sheet P dropped from the waiting tray 10 is stacked is arranged below the waiting tray 10.

While plural sheets P are stapled by the stapler 14 that is a processing mechanism for performing finishing, the processing tray 12 aligns and supports the sheets P to be stacked.

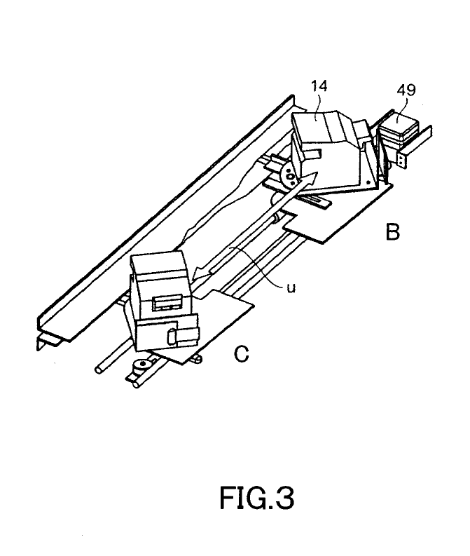

As shown in FIG. 3, the stapler 14 is positioned by a staple driving unit 49 and stapling by the stapler 14 is controlled according to a control signal received from a control unit (not shown) disposed in the finishing apparatus 7.

Information concerning sheets to be subjected to image formation is sent from the image forming apparatus 5 to the control unit of the finishing apparatus 7. First, the stapler 14 changes the position thereof from a home position to be parallel to the front end (a leading end in a sheet conveying direction) of the sheets P and moves to near the center of a sheet width dimension. Subsequently, the stapler 14 moves from near the center of the sheet width in an outward direction of the sheet width horizontally to the front end of the sheets P by a predetermined distance. This is for the purpose of reducing processing time by translating the stapler 14. Therefore, the predetermined distance is suitably set to, for example, ¼ to ⅓ of the width dimension of the sheets P.

The stapler 14 configured to move from near the center of the sheet width to the predetermined position rotates an angle smaller than 45 degrees, for example, 30 degrees in the predetermined position and further moves in the outward direction of the sheet width. After moving forward by a moving distance corresponding to the sheet width, the stapler 14 staples the sheets P in a desired position B or C. Therefore, even if a sheet size is different, stapling is processed at the same angle. The desired position is, for example, a position set by an operator using an operation unit disposed in the image forming apparatus 5. When a designated position is not set by the operator, appropriate position information may be set as the desired position for each of sheet sizes prepared in advance.

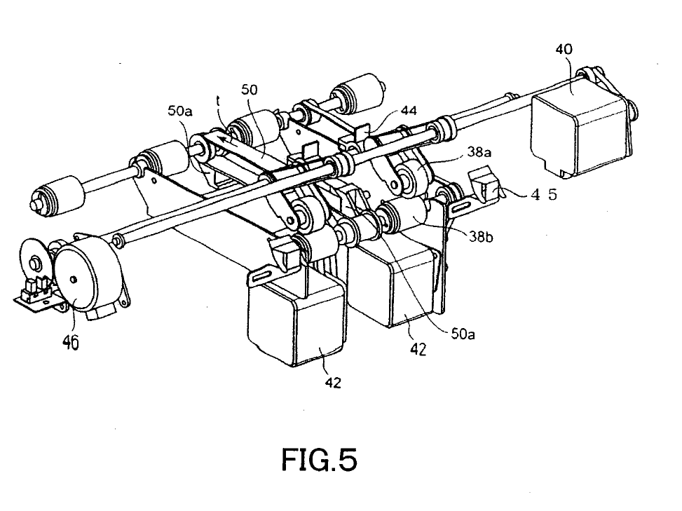

The processing tray 12 includes a pair of upper and lower longitudinal alignment rollers 38a and 38b shown in FIG. 5 configured to align the plural sheets P dropped from the waiting tray 10 in the longitudinal direction that is the conveying direction. The upper and lower longitudinal alignment rollers 38a and 38b also serve as bundle conveying rollers configured to nip a sheet bundle subjected to stapling and extract the sheet bundle from the stapler 14. The upper longitudinal alignment roller 38a is driven by a longitudinal alignment upper roller motor 40. The lower longitudinal alignment roller 38b is driven by a longitudinal alignment lower roller motor 42.

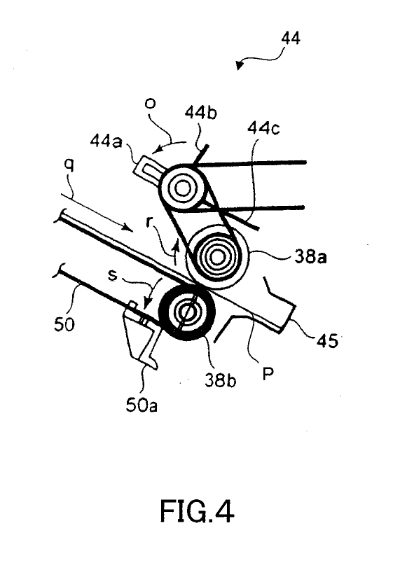

In a position where the trailing end of the sheets P falls when the sheets P are dropped to the processing tray 12, a rotatable paddle 44 for aligning the top sheet P placed on the processing tray 12 in the longitudinal direction is arranged. The paddle 44 includes, as shown in FIG. 4, a receiving section 44a for the sheets P dropped onto the processing tray 12, a patting section 44b for patting down the sheets P onto the processing tray 12, and a feeding section 44c for aligning the sheets P on the processing tray 12. The paddle 44 is driven by a paddle motor 46. The paddle 44 is made of a rubber material and has elasticity.

At an end on the stapler 14 side of the processing tray 12, a stopper 45 configured to come into contact with the trailing end of the sheets P and regulate a trailing end position is provided. Substantially in the center of the processing tray 12, a conveyor belt 50 configured to convey a sheet bundle subjected to stapling and extracted from the stapler 14 by the upper and lower longitudinal alignment rollers 38a and 38b to the first paper discharge tray 16 or the second paper discharge tray 18 is provided. A pawl 50a configured to catch the trailing end of the sheet bundle is provided in the conveyor belt 50.

As shown in FIG. 2, the sheet supporting surfaces of the waiting tray 10 open, whereby the sheets P can be dropped onto the processing tray 12 and can be conveyed in the direction of the first paper discharge tray 16 or the second paper discharge tray 18. The conveyance of the sheets P in the direction of the paper discharge tray 16 or 18 is performed by bringing a waiting tray roller 28 configured to perform alignment of the sheets P into contact with the sheets P on the waiting tray 10. Up and down movement of the waiting tray roller 28 is controlled by a waiting tray roller driving source 30.

The waiting tray 10 is arranged to be tilted at an angle of tilt θ1 in order to support the sheets P with the leading end of the sheets P set higher than the trailing end thereof. The first paper discharge tray 16 or the second paper discharge tray 18 is lifted and lowered by a paper-discharge-tray driving unit 52 and is selected by the operator. The first paper discharge tray 16 or the second paper discharge tray 18 is lifted and lowered to substantially the same height as the waiting tray 10 or the processing tray 12 during stacking of the sheets P to realize improvement of alignability of the sheets P to be discharged. The first paper discharge tray 16 or the second paper discharge tray 18 is arranged to be tilted at an angle of tilt θ2 in order to support the sheets P with the leading end of the sheets P set higher than the trailing end thereof.

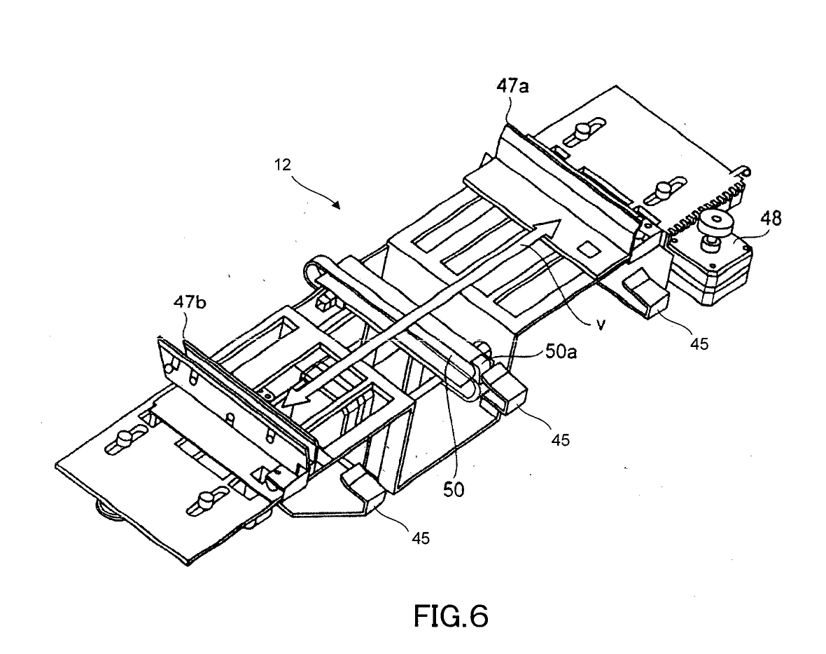

Lateral alignment plates 47a and 47b shown in FIG. 6 are provided in the processing tray 12. The lateral alignment plates 47a and 47b perform lateral alignment to prevent the sheets P from being disarranged in the lateral direction orthogonal to the conveying direction of the sheets P when the pair of sheet supporting surfaces of the waiting tray 10 open and the sheets P on the waiting tray 10 are dropped onto the processing tray 12. As indicated by an arrow v, the lateral alignment plates 47a and 47b are slidably provided to be adjusted to the width of the sheets P by a lateral alignment motor 48.

Actions of the finishing apparatus 7 are explained below. When the sheets P are subjected to image formation in the image forming apparatus 5 and discharged from the paper discharge rollers 6, the finishing apparatus 7 performs different operation according to whether the sheets P are subjected to finishing or whether finishing is being executed on the preceding sheets P or is finished.

If the sheets P are not subjected to the finishing, for example, the first paper discharge tray 16 slides to a position indicated by a dotted line in FIG. 2. The sheets P discharged from the waiting tray 10 can be stacked with high alignability. If the sheets P are not subjected to the finishing, the sheets P conveyed from the inlet rollers 22 to the paper feeding rollers 24 via the paper guide 36 are conveyed to the waiting tray 10 by the paper feeding rollers 24. Subsequently, the sheets P are conveyed by the waiting tray roller 28, which, is lowered onto the waiting tray 10 and rotated in an arrow f direction, and discharged onto the first paper discharge tray 16.

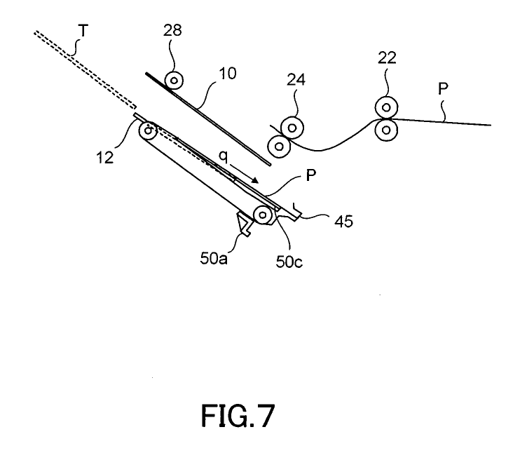

In this way, the sheets P are sequentially stacked on the first paper discharge tray 16. The first paper discharge tray 16 is arranged to be tilted at the angle of tilt θ2 and the leading end of the sheets P is higher than the trailing end thereof. Therefore, even if the sheet P is discharged onto the first paper discharge tray 16 in a curled state as indicated by a dotted line in FIG. 7, the sheet P placed on the first paper discharge tray 16 earlier is not pushed out by coming into contact with the leading end of the following sheet P. In other words, the discharged sheets P are sequentially placed on the first paper discharge tray 16 without being placed in the wrong order. Even if the preceding sheet P is pushed by the following sheet P to slightly cause positional deviation, since the first paper discharge tray 16 is tilted at the angle of tilt θ2, the sheets P fall with the own weight thereof and are stacked on the first paper discharge tray 16 with the trailing end thereof aligned. The paper discharge processing for the sheets P is completed.

Stapling as finishing performed when there are no sheets P being stapled earlier on the processing tray 12 is explained.

In this case, in the waiting tray 10, the pair of sheet supporting surfaces are opened to drop the sheets P onto the processing tray 12. As shown in FIG. 6, the lateral alignment plates 47a and 47b are arranged at a space substantially same as the width of the sheets P in order to align the lateral direction of the sheets P to be dropped. Consequently, the sheets P conveyed by the paper feeding rollers 24 are dropped onto the processing tray 12 through the waiting tray 10.

As shown in FIG. 4, when the sheet P falls, the upper longitudinal alignment roller 38a is retracted upward and the receiving section 44a of the paddle 44 receives the trailing end of the sheet P. The sheet P falls with both sides thereof coming into contact with the lateral alignment plates 47a and 47b and the lateral direction of the sheet P is aligned. Subsequently, the paddle 44 rotates in an arrow o direction, drops the trailing end of the sheet P from the receiving section 44a, and pats down the sheet P onto the processing tray 12 with the patting section 44b. Further, the paddle 44 feeds the sheet P in an arrow q direction with the feeding section 44c, brings the trailing end of the sheet P into contact with the stopper 45, and completes the alignment in the longitudinal direction of the sheet P.

The alignment in the longitudinal direction of the sheets P on the processing tray 12 may be performed by the upper longitudinal alignment roller 38a by moving the upper longitudinal alignment roller 38a up and down every time the alignment is performed.

In this way, while the sheets P subjected to image formation are sequentially aligned in the lateral direction and the longitudinal direction, the sheets P are stacked on the processing tray 12 from the paper feeding rollers 24 through the waiting tray 10. When the number of sheets P reaches a predetermined number, first, the stapler 14 changes the position thereof from the home position to be parallel to the front end (with respect to a sheet conveying direction end) of the sheets P and moves to near the center of the sheet width dimension.

Subsequently, the stapler 14 moves in the outward direction of the sheet width in parallel to the front end of the sheets P by a distance of ¼ to ⅓ of the width dimension of the sheets P from near the center of the sheet width. The stapler 14 that moves from near the center of the sheet width to the predetermined position rotates an angle smaller than 45 degrees, for example, 30 degrees in the predetermined position and further moves in the outward direction of the sheet width. After moving forward by a moving distance corresponding to the sheet width, the stapler 14 staples the sheets P on the processing tray 12 in a bundle state in a desired position and forms a sheet bundle.

Thereafter, the stapler 14 lowers the upper longitudinal alignment roller 38a onto the sheet bundle, nips the sheet bundle with the upper longitudinal alignment roller 38a rotating in an arrow r direction and the lower longitudinal alignment roller 38b rotating in an arrow s direction, and conveys the sheet bundle in the direction of the first paper discharge tray 16.

When the trailing end of the sheet bundle passes through the upper and lower longitudinal alignment rollers 38a and 38b, the sheet bundle is caught by the feeding pawl 50a of the conveyor belt 50 moved in an arrow t direction and is conveyed onto the first paper discharge tray 16.

At this point, the first paper discharge tray 16 is slid from the position indicated by the dotted line to a position indicated by a solid line in FIG. 2. Since the first paper discharge tray 16 is arranged to be tilted at the angle of tilt θ2 and the leading end of the sheets P is higher than the trailing end thereof, the sheet P conveyed onto the first paper discharge tray 16 earlier is not pushed out by coming into contact with the leading end of the following sheet bundle. Even if the preceding sheet bundle is pushed by the following sheet P to slightly cause positional deviation, since the first paper discharge tray 16 is tilted at the angle of tilt θ2, the sheet bundle falls with the own weight thereof and is stacked on the first paper discharge tray 16 with the trailing end thereof aligned. The stapling of the sheets P is completed.

Stapling as finishing performed when the sheets P being stapled earlier remain on the processing tray 12 is explained.

In this case, in the waiting tray 10, the sheets P can be supported. The waiting tray roller 28 is retracted to above the waiting tray 10 not to interfere with the sheets P. The sheet P discharged from the image forming apparatus 5 and supplied by the paper feeding rollers 24 is once placed on the waiting tray 10 to wait for the processing tray 12 to be emptied.

The sheets P placed on the waiting tray 10 are longitudinally aligned by the waiting tray roller 28 rotated in a direction opposite to the arrow f direction (see FIG. 1). Further, since the waiting tray 10 is arranged to be tilted at the angle of tilt θ1 and the leading end of the sheets P is higher than the trailing end thereof, the sheets P are also longitudinally aligned by the own weight thereof.

Since the waiting tray 10 is arranged to be tilted at the angle of tilt θ1, for example, even when the sheet P is fed from the paper feeding rollers 24 in a curled state and supplied onto the waiting tray 10, the sheet P placed on the waiting tray 10 earlier is not pushed out by coming into contact with the leading end of the following sheet P. In other words, the supplied sheets P are sequentially placed on the waiting tray 10 without being placed in the wrong order. Even if the preceding sheet P is pushed by the following sheet P to slightly cause positional deviation, since the waiting tray 10 is tilted at the angle of tilt θ1, the sheets P fall with the own weight thereof and are laterally aligned on the waiting tray 10 with the trailing end thereof aligned.

While the sheets P are placed on the waiting tray 10, when the preceding sheet P on the processing tray 12 is discharged to the first paper discharge tray 16 side and the processing tray 12 is emptied, the waiting tray 10 drops the sheets P onto the processing tray 12. At this point, the lateral alignment plates 47a and 47b are arranged such that a space between the lateral alignment plates 47a and 47b is substantially the same as the width of the sheets P. Therefore, the sheets P dropped from the waiting tray 10 are regulated by the lateral alignment plates 47a and 47b on both sides thereof and aligned in the lateral direction.

As shown in FIG. 4, the sheet P on the lower side of the two sheets P dropped onto the processing tray 12 is fed in the arrow q direction by the lower longitudinal alignment roller 38b rotated in a direction opposite to an arrow a direction and the trailing end of the sheet P is brought into contact with the stopper 45. The alignment in the longitudinal direction of the sheet P is completed. The sheet P on the upper side of the two sheets P dropped onto the processing tray 12 is fed in the arrow q direction by the upper longitudinal alignment roller 38a rotated in a direction opposite to the arrow r direction and the trailing end of the sheet P is brought into contact with the stopper 45. The alignment in the longitudinal direction of the sheet P is completed. Thereafter, the longitudinal alignment roller 38a is retracted upward.

The third and subsequent sheets P discharged from the image forming apparatus 5 are directly dropped onto the processing tray 12 without being kept waiting on the waiting tray 10. The third and subsequent sheets P are sequentially aligned on the sheet P stacked on the processing tray 12 earlier by the paddle 44.

When the number of sheets P stacked on the processing tray 12 reaches the predetermined number, first, the stapler 14 changes the position thereof from the home position to be parallel to the front end (with respect to the sheet conveying direction end) of the sheets P and moves to near the center of the sheet width dimension. Subsequently, the stapler 14 moves in the outward direction of the sheet width in parallel to the front end of the sheets P by a distance of ¼ to ⅓ of the width dimension of the sheets P from near the center of the sheet width. The stapler 14 that moves from near the center of the sheet width to the predetermined position rotates an angle smaller than 45 degrees, for example, 30 degrees in the predetermined position and further moves in the outward direction of the sheet width. After moving forward by a moving distance corresponding to the sheet width, the stapler 14 staples the sheets P on the processing tray 12 in a bundle state in a desired position and forms a sheet bundle.

Thereafter, the sheet bundle is conveyed in the direction of the first paper discharge tray 16 by the upper and lower longitudinal alignment rollers 38a and 38b. Further, the trailing end of the sheet bundle is caught by the feeding pawl 50a (see FIG. 7) of the conveyor belt 50 and the sheet bundle is conveyed onto the first paper discharge tray 16. The stapling of the sheets P is completed.

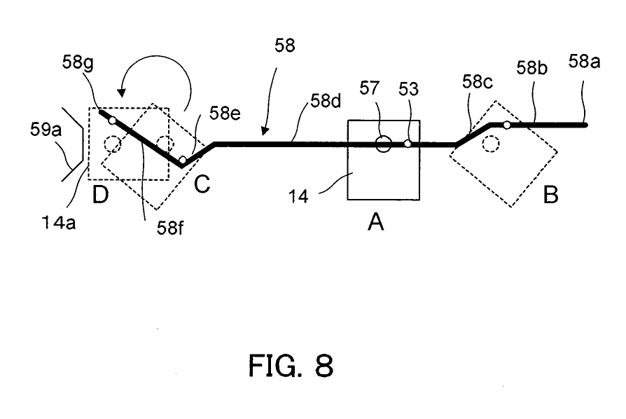

A moving mechanism for moving the stapler 14 is explained in detail below. In FIG. 8, a direction of the stapler 14 at the time when a guide pin 53 provided in the stapler 14 moves along a slit 58 and a positional relation of an insertion port 59 during stapling in the embodiment are shown.

The slit 58 is formed by one slit in which, starting from a first end 58a on the right side, a first linear section 58b, a first inclined section 58a, a second linear section 58d, a second inclined section 58e, a third linear section 58f, and a second end 58g are continuously provided.

The stapler 14 has a center 57 in performing stapling. A direction of the stapler 14 indicated by a dotted line changes according to a relation between the stapler center 57 and the guide pin 53.

In the finishing apparatus 7, when it is instructed in advance to perform stapling, first, the stapler 14 moves to a position A. It is instructed in advance whether a position where sheets are stopped is the upper right or the upper left, whereby the stapler 14 moves to a position B or a position C and performs the stapling.

On the other hand, as in this embodiment, when a bundle of sheets once discharged is inserted from a staple insertion port 59a, the stapler 14 moves to a position D and rotates as indicated by an arrow to be faced toward the staple insertion port 59a.

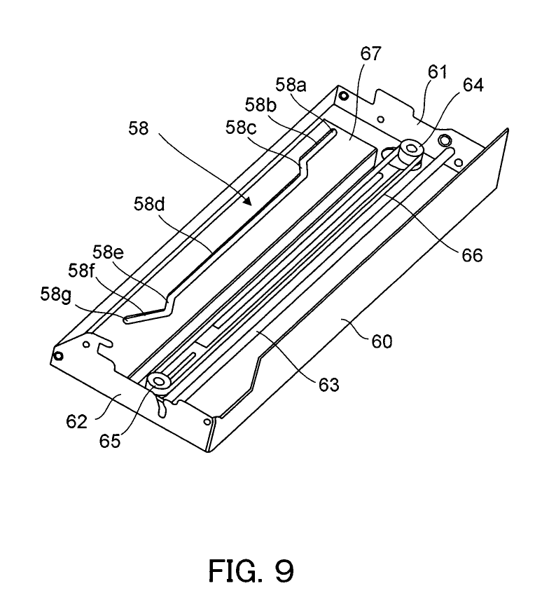

In FIG. 9, the structure of a frame 60, in which the stapler 14 is moved along a guide, is shown. The frame 60 to which the stapler 14 is attached has an elongated box shape as shown in FIG. 9.

A rail 63 of a round bar shape is arranged between one side edge 61 and the other side edge 62 of the frame 60. Further, substantially in the center of the frame 60, a first pulley 64 is provided near the side edge 61 and a second pulley 65 is provided near the side edge 62.

The first pulley 64 is, connected to a not-shown motor to be driven to rotate normally and reversely. An endless belt 66 is laid over the first pulley 64 and the second pulley 65. A slit table 67 is provided on the opposite side of the rail 63 across the endless belt 66. The slit 58 for controlling the movement of the stapler 14 is formed in the slit table 67.

As explained with reference to FIG. 8, as shown in FIG. 9, the slit 58 is formed by one slit in which, starting from the first end 58a on the upper right side, the first linear section 58b, the first inclined section 58c, the second linear section 58d, the second inclined section 58e, the third linear section 58f, and the second end 58g are continuously provided. The first inclined section 58c and the second inclined section 58e are inclined at an angle of 30 degrees smaller than 45 degrees with respect to the first linear section 58b and the second linear section 58d.

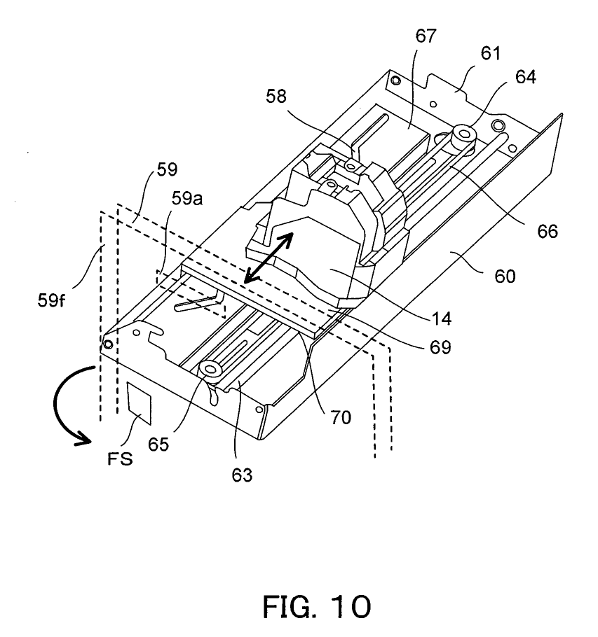

In FIG. 10, a state in which the stapler 14 is movably attached on the frame 60 shown in FIG. 9. The stapler 14 is moved along the entire length of the slit 58. In other words, the stapler 14 is swingably attached on a moving plate 69. The guide pin 53 is fixed to one end of the stapler 14 and inserted in the slit 58. Therefore, the stapler 14 swings to tilt at a predetermined angle along the shape of the slit 58. The moving plate 69 on which the stapler 14 is placed is movably attached to the rail 63 via a support pipe 70 fixed to the lower surface of the moving plate 69.

The moving plate 69 is attached to the endless belt 66. Specifically, the endless belt 66 rotates in first and second directions according to the normal and reverse rotation of the first pulley 64, over which the endless belt 66 is laid, to move the moving plate 69 in the first direction and the opposite second direction.

According to the rotation of the endless belt 66, when the stapler 14 starts from the first end 58a of the slit 58, the stapler 14 rotates 30 degrees in a portion where the slit 58 changes from the first inclined section 58c to the second linear section 58d. This 30-degree rotated state indicates a state of the stapler 14 in the position B in FIG. 3. A staple of the stapler 14 can be driven into a corner of plural sheets (a sheet bundle) SP desired to be stapled.

In order to change a position where sheets are stapled and a staple is driven into a corner of the sheet bundle SP, when the slit 58 changes from the second linear section 58d to the second inclined section 58e, the stapler rotates 30 degrees at the opposite tilt. This 30-degree rotated state indicates a state of the stapler 14 in the position C in FIG. 4. A staple of the stapler 14 can be automatically driven into another corner of the sheets P.

In the second linear section 58d, the stapler 14 is parallel to an edge of the sheet bundle SP and operates to drive a pair of staples into the sheets P in one row. Moving speed of the stapler 14 between the pair of staples is about 310 mm/sec. Initial moving speed of the stapler 14 to one staple position or two staple positions is about 110 mm/sec. Moving speed of the stapler 14 at the initial time and to a sensor provided in the home position is about 90 mm/sec.

Further, the slit 58 in this embodiment has a third linear section 58f and a second end 58g continuously from the second inclined section 58e. A front cover 59f is provided in front of a stapler cover 59 (indicated by a dotted line in FIG. 10) in which the staple insertion port 59a is provided. When the front cover 59f is opened, a front cover detection sensor FS detects that the front cover 59f is opened. When the front cover 59f is opened, the stapler 14 is guided to the third linear section 58f by the slit 58. At this point, as indicated by the position D in FIG. 8, the stapler 14 rotates and an opening 14a of the stapler 14 is faced to the staple insertion port 59a.

With the moving mechanism for the stapler explained above, the stapler 14 can be moved to the predetermined position along the shape of the slit 58 and rotated the predetermined angle only by one driving source. Therefore, the structure of the driving mechanism is simple. In other words, another driving source for rotating the stapler 14 the predetermined angle is unnecessary.

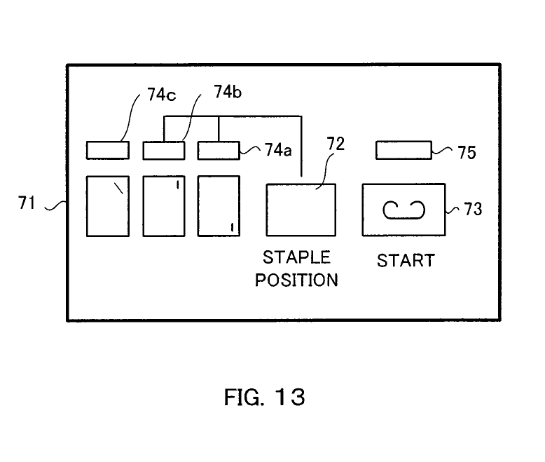

An operation unit for manual operation is provided in an upper part of the finishing apparatus 7. As shown in FIG. 13, a switch 72 for staple position selection and a start switch 73 are provided on an upper surface 71 of the operation unit. Indicator sections 74a and 74b include LEDs that are turned on in response to the selection switch 72. Lighting of the indicator sections 74a and 74b indicates that staple selection positions are positions shown below the indicator sections 74a and 74b. Lighting of an indicator section 74c indicates that the corner of the sheet bundle SP is manually stapled in a state in which the corner is inserted into the stapler 14. When preparation is completed, the start switch 73 is, for example, flashed. When the switch 73 is pressed, an indicator section 75 including an LED is lit. When the stapling is completed, the start switch 73 is lit.

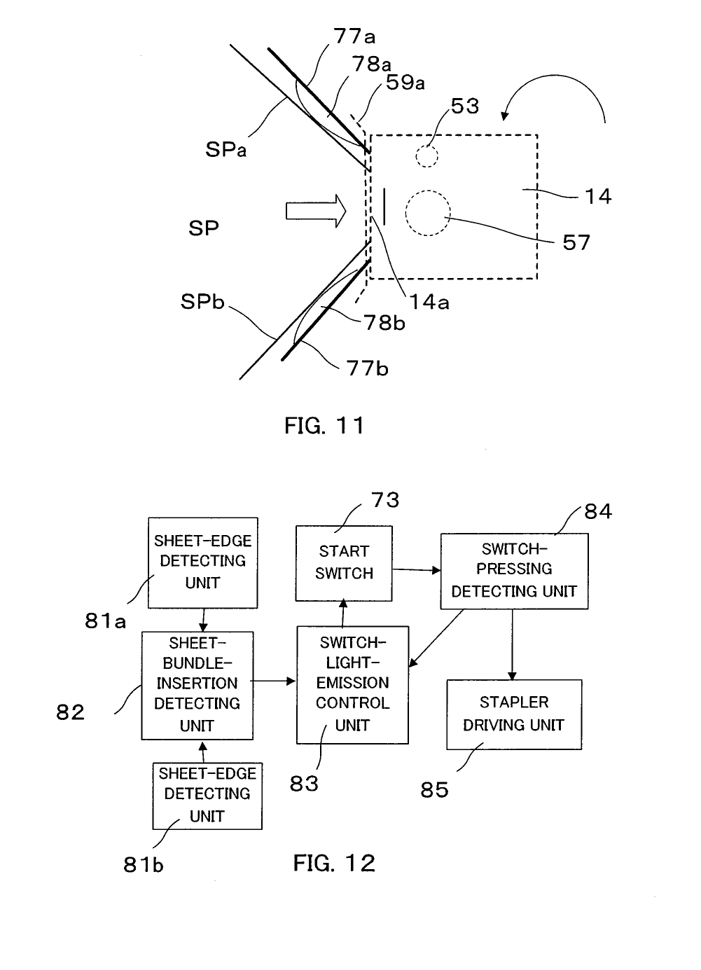

In FIG. 11, a state of the finishing apparatus 7 at the time when the sheet bundle SP to be stapled is inserted into the opening 14a of the stapler 14 is shown. The finishing apparatus 7 has contact sections 77a and 77b with which edges SPa and SPb of a sheet bundle come into contact when the sheet bundle SP is inserted into the opening 14a of the stapler 14. Edge detection switches 78a and 78b are provided in the contact sections 77a and 77b. The edge detection switches 78a and 78b are, for example, actuator switches. The edge detection switches 78a and 78b are usually off and are turned on when pressed by edges of the sheet bundle SP.

In FIG. 12, a configuration example of an electric circuit of an insertion stapling unit at the time when a sheet bundle is inserted and stapled is shown. The insertion stapling unit includes sheet-edge detecting units 81a and 81b configured to detect the edges SPa and SPb of the sheet bundle SP with edge detection switches 78a and 78b, a sheet-bundle-insertion detecting unit 82 configured to detect, with these detecting units, that both the edge detection switches 78a and 78b are turned on and detect insertion of the sheet bundle SP, a switch-light-emission control unit 83 configured to cause the start switch 73 to emit light and flash in order to indicate completion when the sheet-bundle-insertion detecting unit 82 detects insertion of the sheet bundle SP, a switch-pressing detecting unit 84 configured to detect, when the start switch 73 is pressed by a user, the pressing and send a control signal to the switch-light-emission control unit 83 to stop the light emission of the start switch 73, and a stapler driving unit 85 configured to drive the stapler 14 according to a detection signal from the switch-pressing detecting unit 84 and cause the stapler 14 to perform stapling.

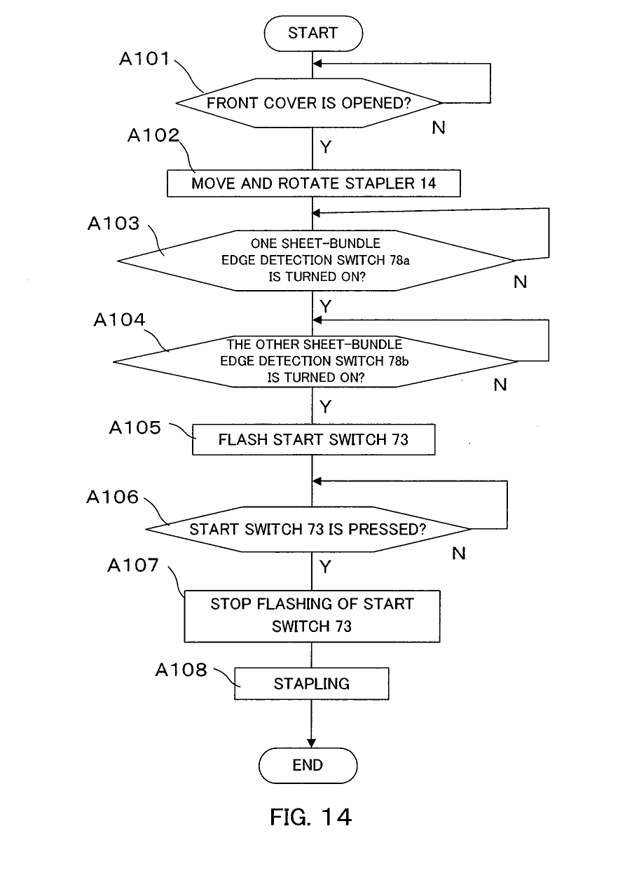

Operation in a manual mode in which an end of the sheet bundle SP desired to be stapled is inserted into the opening of the stapler 14 and stapled is explained according to a flowchart shown in FIG. 14.

When the operation is started, first, in Act A101, the insertion stapling unit detects whether the front cover 59f of the finishing apparatus 7 is opened. If the front cover detection sensor FS detects that the front cover 59f is opened, the insertion stapling unit moves the stapler 14 to the third linear section 58f and rotates the stapler 14 (Act A102). The user inserts a sheet bundle into the staple insertion port 59a in a state in which the front cover 59f is opened.

In Act A103, the insertion stapling unit detects whether one sheet bundle edge detection switch 8a is turned on. If it is detected that the sheet bundle edge detection switch 8a is turned on, in Act A104, the insertion stapling unit detects whether the other sheet bundle edge detection switch 8b is turned on. If the sheet bundle edge detection switch 8a is not turned on, the insertion stapling unit cannot shift to Act A104 for detecting whether the other sheet bundle edge detection switch 8b is turned on. The insertion stapling unit waits until the sheet bundle edge detection switch 8a is turned on. If the sheet bundle edge detection switch 8b is not turned on, the insertion stapling unit cannot shift to the next stage (A105). Both the sheet bundle edge detection switches 8a and 8b are turned on by edges of adjacent two sides of the sheet bundle SP. This means that, as shown in FIG. 11, the sheet bundle SP is inserted deep into the opening 14a of the stapler 14 and stapling is properly performed.

If both the sheet bundle edge switches 8a and 8b are turned on, the sheet-bundle-insertion detecting unit 82 detects completion of preparation for the stapling and sends a control signal to the switch-light-emission control unit 83. The switch-light-emission control unit 83 sends a flashing control signal to the start switch 73 and, in the next Act A105, causes the start switch 73 to flash. The flashing of the start switch 73 informs the user that a sheet bundle about to be stapled is appropriately inserted into the staple insertion port 59a, i.e., the preparation for the stapling is completed. The start switch 73 may be continuously lit rather than being flashed. The lighting includes the flashing and the continuous lighting.

In the next Act A106, the switch-pressing detecting unit 84 detects whether the start switch 73 is pressed. If the switch-pressing detecting unit 84 detects in Act A106 that the start switch 73 is pressed, i.e., the switch-pressing detecting unit 84 receives a switch press signal from the start switch 73, the switch-pressing detecting unit 84 sends a flashing stop control signal to the switch-light-emission control unit 83 and, in Act A107, stops the flashing of the start switch 73. The display unit 75 is lit at this point.

In the next Act A108, the switch-pressing detecting unit 84 sends a driving control signal to the stapler driving unit 85. The stapler driving unit 85 causes the stapler 14 to perform the stapling.

Although not explained in detail, when the front cover 59f of the finishing apparatus 7 is not opened and stapling is instructed, the stapler 14 is guided by the slit on the slit table 67 to move and automatically applies, in the predetermined position, stapling to a sheet bundle conveyed thereto.

According to this embodiment, a stapler usually used for stapling by the finishing apparatus can also be used for stapling a sheet bundle in the manual mode. Therefore, even when it is not instructed in advance to automatically perform stapling, the sheet bundle can be easily stapled.

In this embodiment, when the front cover is opened, the finishing apparatus detects the opening of the front cover and shifts to the manual mode. Therefore, in order to set the finishing apparatus in the manual mode, the user only has to open the front cover and does not need to specially instruct the manual mode.

In the example explained in the embodiment, when the two switches, with which adjacent ends of a sheet bundle come into contact, are turned on, the start switch is flashed to inform the user of the completion of the preparation and, when the user presses the start switch, stapling is performed. However, the completion of the preparation for the stapling may be indicated by flashing of the start switch or may be informed to the user by other switches and lamps. It is also possible to automatically perform the stapling when the preparation for the stapling is completed even if the user does not press the switch. In this case, for example, in FIG. 11, an output of the sheet-bundle-insertion detecting unit 82 may be input to the stapler driving unit 85.

In this embodiment, when the finishing apparatus of the image forming apparatus shifts to the manual mode, an inserted sheet bundle is stapled by the stapler.

However, the stapler does not need to be incorporated in the finishing apparatus. The present invention can also be separately applied to the stapler. In this case, when a sheet bundle is inserted into the opening of the stapler, the pressing switches on both sides of the opening turn on and detect that the sheet bundle is properly inserted and inform the user of the completion of preparation for stapling with a lamp or the like. When the user presses a switch for stapling, the stapling is performed.

While certain embodiments have been described, these embodiments have been presented by way of example only, and are not intended to limit the scope of the inventions. Indeed, the novel systems and methods described herein may be embodied in a variety of other forms: furthermore, various omissions, substitutions and changes in the form of the systems described herein may be made without departing from the spirit of the inventions. The accompanying claims and their equivalents are intended to cover such forms or modifications as would fall within the scope and spirit of the inventions.

What is claimed is:

1. A stapling apparatus comprising:
a stapler having an opening, into which plural sheets are inserted while being laid one on top of another, and configured to staple one end of the sheets;
first and second switches configured to be turned on when the sheets are inserted into the opening of the stapler and respective edges of adjacent two sides of the sheets are pressed; and
a stapler driving unit configured to instruct the stapler to perform stapling when both the first and second switches are turned on.

2. The apparatus according to claim 1, wherein, when at least one of the first and second switches is not turned on, the stapler driving unit does not instruct the stapler to perform the stapling.

3. The apparatus according to claim 2, wherein the stapler driving unit includes:
a preparation-completion indicating section configured to indicate completion of preparation for the stapling when both the first and second switches are turned on; and
a start switch with which a user instructs start of the stapling.

4. The apparatus according to claim 3, wherein the indication of the completion of the preparation for the stapling by the preparation-completion indicating section is lighting of a lamp.

5. The apparatus according to claim 2, wherein, when both the first and second switches are turned on, the stapler driving unit automatically instructs the stapler to perform the stapling.

6. A finishing apparatus of an image forming apparatus, comprising:
an aligning unit configured to receive sheets subjected to image formation and discharged by the image forming apparatus and perform aligning for aligning the sheets;
a stapler configured to perform stapling for stapling an end of the sheets aligned by the aligning unit;
a start switch for starting the stapling performed by the stapler;
a stapler moving mechanism unit configured to move, in a manual mode for individually using the stapler, the stapler to face an opening of the stapler to an outside;
first and second switches configured to be turned on when the sheets are inserted into the opening of the stapler moved by the stapler moving mechanism unit and respective edges of adjacent two sides of the sheets are pressed; and
a stapler driving unit configured to instruct the stapler to perform the stapling when both the first and second switches are turned on.

7. The apparatus according to claim 6, wherein, when at least one of the first and second switches is not turned on, the stapler driving unit does not instruct the stapler to perform the stapling.

8. The apparatus according to claim 7, wherein the stapler driving unit includes:
a preparation-completion indicating section configured to indicate completion of preparation for the stapling when both the first and second switches are turned on; and
a start switch with which a user instructs start of the stapling.

9. The apparatus according to claim 8, wherein the apparatus shifts to the manual mode when a front panel provided in front of the opening of the stapler is opened.

10. The apparatus according to claim 9, wherein the indication of the completion of the preparation for the stapling by the preparation-completion indicating section is lighting of the start switch.

11. The apparatus according to claim 10, wherein the stapler moving mechanism unit includes a box-like frame and an endless belt configured to reciprocatingly move the stapler in the frame.

12. The apparatus according to claim 11, wherein the stapler moving mechanism unit further includes a slit table provided in the frame and having a bending slit and moves and rotates the stapler by guiding a guide pin of the stapler along the slit.

13. The apparatus according to claim 7, wherein, when both the first and second switches are turned on, the stapler driving unit automatically instructs the stapler to perform the stapling.

14. A stapling method comprising:
when plural sheets are inserted into an opening of a stapler, into which the sheets are inserted while being laid one on top of another, first and second switches, with which respective edges of adjacent two sides of the sheets come into contact, being turned on when pressed;
when both the first and second switches are turned on, instructing the stapler to perform stapling for stapling the sheets; and
the stapler having the opening performing the stapling according to the instruction for the stapling.

15. A stapling method in a finishing apparatus of an image forming apparatus, comprising:
receiving sheets subjected to image formation and discharged by the image forming apparatus, performing aligning for aligning the sheets, and performing stapling for stapling, with a stapler configured to perform the stapling, an end of the sheets aligned by the aligning unit;
moving, in a manual mode, the stapler with a stapler moving mechanism unit to face an opening of the stapler performing the stapling to an outside; and
when first and second switches, with which respective edges of adjacent two sides of the sheets come into contact, are turned on when the sheets are inserted into the opening of the stapler moved by the stapler moving mechanism unit, instructing, with a stapler driving unit, the stapler to perform the stapling.

16. The method according to claim 15, wherein the stapler driving unit indicates completion of preparation for the stapling when both the first and second switches are turned on and, when a user presses a processing instruction switch, instructs the stapler to perform the stapling.

17. The method according to claim 16, further comprising shifting to the manual mode when a front panel provided in a front of the opening of the stapler is opened.

18. The method according to claim 17, wherein the indication of the completion of the preparation for the stapling is lighting of a start switch for starting the stapling.

19. The method according to claim 18, wherein the stapler moving mechanism unit includes a box-like frame and an endless belt configured to reciprocatingly move the stapler in the frame.

20. The method according to claim 19, wherein the stapler moving mechanism unit further includes a slit table provided in the frame and having a bending slit and moves and rotates the stapler by guiding a guide pin of the stapler along the slit.

21. The method according to claim 15, wherein, when both the first and second switches are turned on, the stapler driving unit automatically instructs the stapler to perform the stapling.
